(19) United States
(12) Patent Application Publication
(10) Pub. No.: US 2008/0302872 A1
(43) Pub. Date: Dec. 11, 2008

(54) DISCOUNT CARD APPLICATION SYSTEM AND METHOD

(76) Inventor: Timothy Scott Tate, Youngsville, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/760,025

(22) Filed: Jun. 8, 2007

(51) Int. Cl. G06K 7/10

(52) U.S. Cl. 235/462.07

(57) ABSTRACT

To improve the consumer experience with retail rewards and discount programs, a system and method is provided for consolidating information relating to multiple rewards or discount programs in a manner that is convenient and reduces or eliminates the need to carry numerous rewards cards. The system and method of the present invention provides a mechanism for inputting and storing in an electronic device coded information, such as barcodes and QR codes, that may be contained on a coded dataset source, such as a rewards or discount card. In an exemplary embodiment, the electronic device is a mobile telephone. At a retail checkout, the coded information is displayed on the mobile device, and the cashier may scan the display of the mobile device in the same manner as one would scan a discount card.

### TECHNICAL FIELD OF THE INVENTION

The technology of the present disclosure relates generally to coded information, such as barcodes one might find on a rewards or discount card, and, more particularly, to a system and method for using such coded cards in conjunction with a mobile device, such as a mobile telephone.

### DESCRIPTION OF THE RELATED ART

Linear barcodes are ever increasing in use in the retail industry for tracking inventory and shipping, implementing sales, and many other purposes. Generally, a linear barcode consists of a numeric or alphanumeric string that is coded into a series of vertical bars of varying thicknesses and spacing. There are numerous barcode standard formats, although in the retail industry code formats known as Code 39, Code 128, and UPC are common. In each of these formats, a twelve-digit numeric string is converted into the barcode. Examples of each are depicted in FIGS. 1A (Code 39), 1B (Code 128), and 1C (UPC).

In addition to linear barcodes, two-dimensional matrix code formats are also gaining popularity. Instead of a linear series of bars, two-dimensional matrix codes represent data in a square or other two-dimensional matrix. One such coding standard gaining popularity is the QR (for “Quick Response”) code for storing text, numeric, alphanumeric, binary, or graphical information. Although initially developed as a mechanism for tracking inventory of manufacturing parts, the use of QR codes has expanded into more consumer-oriented applications as a means for entering and exchanging data such as names and addresses, business information, product information, etc. An exemplary QR code is depicted in FIG. 2.

Retailers increasingly are using coded information, in barcodes or QR codes, in connection with providing frequent buyer rewards or discount programs. Retailers offering rewards programs are myriad, including grocery stores, drug stores, electronics stores, video rental stores, gas stations, restaurants, entertainment venues, and others. In such programs, repeat customers receive rewards for frequent and repeat business. The rewards may be free merchandise, coupons usable towards future purchases, access to special promotions, or other rewards deemed appropriate by the retailer. Typically, a given retailer issues each participating consumer a frequent buyer rewards or discount card containing a barcode (or other code) personalized for that consumer. When the consumer makes a purchase, the rewards card is scanned with a barcode scanner so that the consumer's purchases are tracked. For each purchase, the consumer may receive points or some other measurement commensurate with the value of the purchase. When the consumer has made a sufficient number of purchases, attained a sufficient level of points, or otherwise met rewards criteria, the retailer issues a reward.

Consumers have a substantial financial incentive to participate in rewards programs of the retailers they frequent. As the number of rewards programs has increased, however, so has the number of cards that a consumer must carry. It often is inconvenient for a consumer to carry cards for all the retailers one might frequent. Many rewards cards are the size of a typical credit card or bank debit/ATM card. Carrying more than a couple of such cards in a wallet or purse quickly becomes unwieldy. Some rewards cards are keychain cards, which are of smaller size and contain a hole for sliding onto a keychain. Despite their smaller size, carrying more than a few such cards on a keychain likewise is unwieldy.

Attempts have been made to reduce the number of cards a consumer must carry. Some retailers have joined together in cooperative rewards programs so that a single card may be used at more than one retailer. Cooperative programs, however, are far more rare than single-retailer programs. In addition, businesses have been created that claim to be able to consolidate the information on several rewards cards into a single card. Generally, however, storage space on consolidated cards is limited to a specific number of input cards, and retailers generally have not sanctioned this use of their rewards cards and programs.

Accordingly, prior attempts at reducing the number of cards a consumer must carry have been largely unsuccessful. As a result, a consumer must suffer the inconvenience of carrying all the rewards cards at once. Alternatively, the consumer may attempt to carry only those cards that might be needed on a given shopping trip. Should the consumer forget a card, or make an unplanned stop, the benefits of the particular rewards program may not be attained.

### SUMMARY

To improve the consumer experience with retail rewards and discount programs, there is a need in the art for a system and method for consolidating information relating to multiple rewards or discount programs in a manner that is convenient and reduces or eliminates the need to carry numerous rewards cards. The system and method of the present invention provides a mechanism for inputting and storing in an electronic device coded information, such as barcodes and QR codes, that may be contained on a coded dataset source, such as a rewards or discount card. In an exemplary embodiment, the electronic device is a mobile telephone. At a retail checkout, the coded information is displayed on the mobile device, and the cashier may scan the display of the mobile device in the same manner as one would scan a discount card.

Therefore, according to one aspect of the invention, an electronic device includes an input device for inputting a plurality of input datasets, wherein each input dataset corresponds to a coded graphical representation, a controller that converts an input dataset selected from the plurality of input datasets, in response to a user input, into the corresponding coded graphical representation, and a display that displays the corresponding coded graphical representation, wherein the displayed coded graphical representation may be subjected to a reading device for interpreting the coded graphical representation.

According to one embodiment of the electronic device, one or more of the input datasets originate from coded cards.

According to one embodiment of the electronic device, the input mechanism is a keypad, and the controller is configured to receive as input datasets numeric or alphanumeric strings that are inputted using the keypad.

According to one embodiment of the electronic device, the input mechanism is a camera, and the controller is configured to receive as input datasets photographs that are inputted by photographing the coded graphical representations.

According to one embodiment of the electronic device, the input mechanism is a scanner, and the controller is configured to receive as input datasets scanned images that are inputted by scanning the coded graphical representations.

According to one embodiment of the electronic device, the electronic device is a mobile telephone.

According to one embodiment of the electronic device, the controller converts the selected input data set to a linear barcode.

According to one embodiment of the electronic device, the linear barcode is one of a Code 39, Code 128, or UPC linear barcode.

According to one embodiment of the electronic device, the controller converts the selected input dataset to a two-dimensional matrix code.

According to one embodiment of the electronic device, the two-dimensional matrix code is a QR code.

According to another aspect of the invention, a method of using coded graphical representations in conjunction with an electronic device includes the steps of inputting into the electronic device a plurality of input datasets, wherein each input dataset corresponds to a coded graphical representation, selecting one input dataset from the plurality of input datasets, converting the selected dataset within the electronic device to the corresponding coded graphical representation, displaying the corresponding coded graphical representation on a display on the electronic device, and subjecting the displayed coded graphical representation on the display to a reading device for interpreting the coded graphical representation.

According to one embodiment of the method, one or more of the input datasets originate from coded cards.

According to one embodiment of the method, the coded graphical representation is a linear barcode.

According to one embodiment of the method, the linear barcode is one of a Code 39, Code 128, or UPC barcode.

According to one embodiment of the method, the coded graphical representation is a two-dimensional matrix code.

According to one embodiment of the method, the two-dimensional matrix code is a QR code.

According to one embodiment of the method, the electronic device has a keypad, and the input datasets are a numeric or alphanumeric strings that are inputted using the keypad.

According to one embodiment of the method, the electronic device has a camera, and the input datasets are photographs that are inputted by photographing the coded graphical representations.

According to one embodiment of the method, the electronic device has a scanner, and the input datasets are scanned images that are inputted by scanning the coded graphical representations.

According to one embodiment of the method, the reading device is an optical scanner.

According to one embodiment of the method, the electronic device is a mobile telephone.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIGS. 1A-C are representations of exemplary linear barcodes, including formats Code 39 (FIG. 1A), Code 128 (FIG. 1B), and UPC (FIG. 1C).

FIG. 2 is a representation of an exemplary QR code.

FIGS. 3A-D are schematic front views of a mobile telephone as an exemplary electronic device for use in accordance with an embodiment of the present invention.

FIG. 4 is a schematic block diagram of operative portions of the mobile telephone of FIGS. 3A-D.

FIG. 5 is a schematic diagram of a communications system in which the mobile telephone of FIGS. 3A-D may operate.

FIG. 6A is a schematic front view of an exemplary coded card for use in accordance with an embodiment of the present invention.

FIG. 6B is a schematic back view of the exemplary coded card of FIG. 6A.

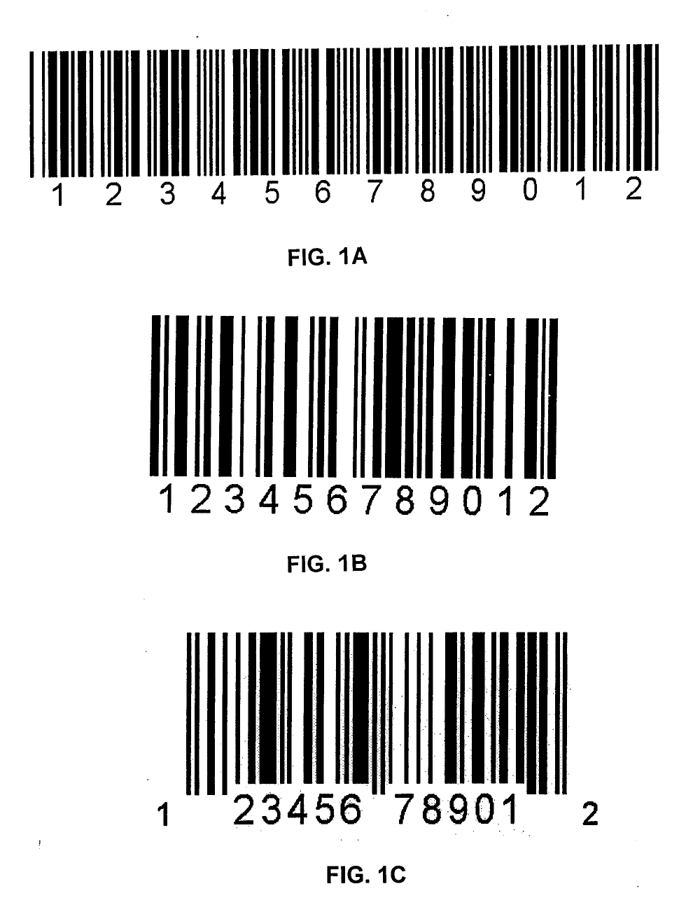

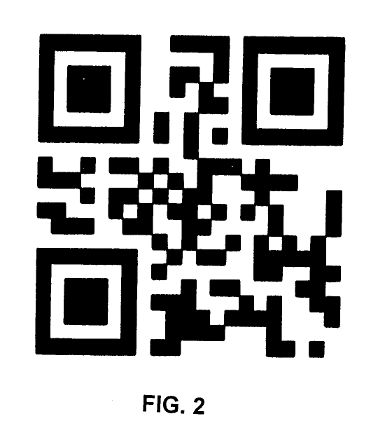

### DETAILED DESCRIPTION OF EMBODIMENTS

Embodiments of the present invention will now be described with reference to the drawings, wherein like reference numerals are used to refer to like elements throughout. It will be understood that the figures are not necessarily to scale.

The following description is made in the context of a mobile telephone. It will be appreciated that the invention is not intended to be limited to the context of a mobile telephone and may relate to any type of appropriate electronic equipment, examples of which include a media player, a gaming device, or a computer. For purposes of the description herein, the interchangeable terms “electronic equipment” and “electronic device” also may include portable radio communication equipment. The term “portable radio communication equipment,” which sometimes hereinafter is referred to as a “mobile radio terminal,” includes all equipment such as mobile telephones, pagers, communicators, electronic organizers, personal digital assistants (PDAs), smartphones, and any portable communication apparatus or the like.

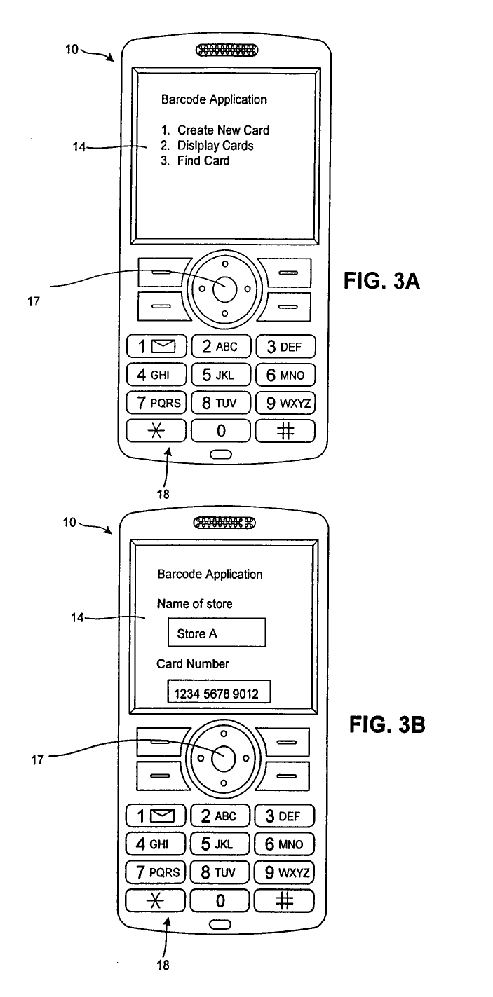

Referring initially to FIGS. 3A-D, mobile telephone 10 has a display 14 that may display information in accordance with aspects of the present invention. In FIG. 3A, display 14 displays a conventional menu that may be used for a barcode application contained in mobile telephone 10. The barcode application permits the user to store and manipulate coded information from a plurality of coded dataset sources, such as store discount or rewards program cards. In the exemplary menu of FIG. 3A, the user may be provided with various options including creating a new card, displaying cards already stored, or finding a particular card already stored. A particular option may be selected using a keypad 18. Keypad 18 may be used to scroll through the menu options, enter the number of the desired option, or select an option by other conventional means.

In FIG. 3B, display 14 displays information that may pertain to an individual discount or rewards card. As shown in the example of FIG. 3B, such information may include the name of the retailer and the card number for that particular card. When creating a new card, in one embodiment the card number may be entered using keypad 18. As further described below, other methods of entry, such as photographing or scanning a card, may be used. The barcode application may include a barcode generator for generating a coded graphical representation of the card number, as shown in FIG. 3C. In the example of FIG. 3C, the coded graphical representation is a linear barcode. At a retail checkout, the coded graphical representation may be scanned from the display by a cashier using a conventional scanner, in much the same way as one would scan a coded card.

A user may participate in numerous rewards and discount programs from a variety of retailers. Information from the cards of the various retailers may be stored in mobile telephone 10. In FIG. 3D, a conventional menu may list the various retailers about which the user has stored information. At checkout, the user may select the appropriate retailer, and display 14 may display the coded graphical representation that corresponds to that on the discount card for the appropriate retailer.

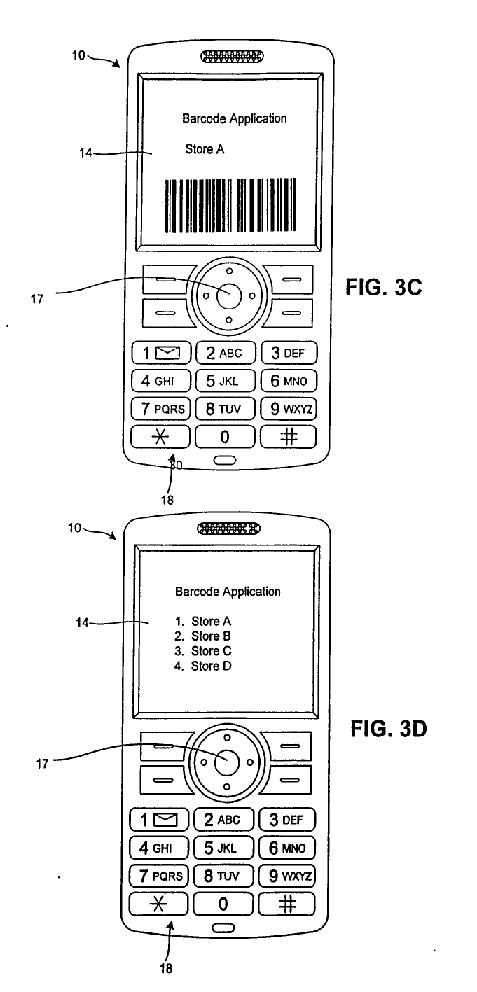

Referring to FIGS. 3A-D and 4, the features of mobile telephone 10 will now be described. FIG. 4 represents a functional block diagram of the mobile telephone 10. For the sake of brevity, generally conventional features of the mobile telephone 10 will not be described in great detail herein. The mobile telephone 10 includes a coded dataset application program 23 for carrying out the features of the invention, as will be described in greater detail below. Application 23 may be a barcode application as exemplified in FIGS. 3A-D. Application 23 may be embodied as executable code that is resident in and executed by the mobile telephone 10. The mobile telephone 10 may include a controller or processor that executes a program stored on a computer or machine-readable medium. The program may be a stand-alone software application or form a part of a software application that carries out additional tasks related to the mobile telephone 10.

As stated above, mobile telephone 10 may include a display 14. The display 14 displays information to a user such as operating state, time, telephone numbers, contact information, various navigational menus, etc., which enable the user to utilize the various features of the mobile telephone 10. The display 14 also may be used to visually display content received by the mobile telephone 10 and/or retrieved from a memory 16 (FIG. 4) of the mobile telephone 10. The display 14 may be used to present images, video and other graphics to the user, such as photographs, mobile television content and video associated with games. Also, the display 14 may be used as an electronic viewfinder for a camera assembly 42. Display 14 also may be used as an electronic interface for a scanner assembly 43, which may be an optical scanner.

As stated above, a keypad 18 provides for a variety of user input operations. For example, keypad 18 typically includes alphanumeric keys for allowing entry of alphanumeric information such as telephone numbers, phone lists, contact information, notes, etc. In addition, keypad 18 typically includes special function keys such as a “call send” key for initiating or answering a call, and a “call end” key for ending or “hanging up” a call. Special function keys also may include menu navigation and select keys to facilitate navigating through a menu displayed on the display 14. Special function keys may include audiovisual content playback keys to start, stop and pause playback, skip or repeat tracks, and so forth. Other keys associated with the mobile telephone may include a volume key, an audio mute key, an on/off power key, a web browser launch key, etc. Some or all of the keys may be used in conjunction with the display as soft keys. Keys or key-like functionality also may be embodied as a touch screen associated with the display 14. When camera assembly 42 or scanner assembly 43 are activated, keys from the keypad 18 may be used to control operation of the camera or scanner assemblies. For instance, one of the keys may serve as a shutter button/scanning initiator 17.

The mobile telephone 10 includes call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi, WiMax, etc. Another example includes a video enabled call that is established over a cellular or alternative network.

The mobile telephone 10 may be configured to transmit, receive, and/or process data such as text messages (e.g., colloquially referred to by some as “an SMS,” which stands for simple message service), electronic mail messages, multimedia messages (e.g., colloquially referred to by some as “an MMS,” which stands for multimedia message service), image files, video files, audio files, ring tones, streaming audio, streaming video, data feeds (including podcasts) and so forth. Processing such data may include storing the data in the memory 16, executing applications to allow user interaction with data, displaying video and/or image content associated with the data, outputting audio sounds associated with the data and so forth.

The mobile telephone 10 includes a primary control circuit 20 that is configured to carry out overall control of the functions and operations of the mobile telephone 10. The control circuit 20 may include a processing device 22, such as a CPU, microcontroller or microprocessor. The processing device 22 executes code stored in a memory (not shown) within the control circuit 20 and/or in a separate memory, such as the memory 16, in order to carry out operation of the mobile telephone 10. The memory 16 may be, for example, one or more of a buffer, a flash memory, a hard drive, a removable media, a volatile memory, a non-volatile memory or other suitable device.

The mobile telephone 10 may include an antenna 24 coupled to a radio circuit 26. The radio circuit 26 includes a radio frequency transmitter and receiver for transmitting and receiving signals via the antenna 24 as is conventional. The radio circuit 26 may be configured to operate in a mobile communications system and may be used to send and receive data and/or audiovisual content. Receiver types for interaction with a mobile radio network and/or broadcasting network include, but are not limited to, GSM, CDMA, WCDMA, GPRS, WiFi, WiMax, DVB-H, ISDB-T, etc., as well as advanced versions of these standards.

The mobile telephone 10 further includes a sound signal processing circuit 28 for processing audio signals transmitted by and received from the radio circuit 26. Coupled to the sound processing circuit 28 are a speaker and a microphone that enable a user to listen and speak via the mobile telephone 10 as is conventional. The radio circuit 26 and sound processing circuit 28 are each coupled to the control circuit 20 so as to carry out overall operation. Audio data may be passed from the control circuit 20 to the sound signal processing circuit 28 for playback to the user. The audio data may include, for example, audio data from an audio file stored by the memory 16 and retrieved by the control circuit 20, or received audio data such as in the form of streaming audio data from a mobile radio service. The sound processing circuit 28 may include any appropriate buffers, decoders, amplifiers and so forth.

The display 14 may be coupled to the control circuit 20 by a video processing circuit 34 that converts video data to a video signal used to drive the display 14. The video processing circuit 34 may include any appropriate buffers, decoders, video data processors and so forth. The video data may be generated by the control circuit 20, retrieved from a video file that is stored in the memory 16, derived from an incoming video data stream received by the radio circuit 28 or obtained by any other suitable method.

The mobile telephone 10 may further include one or more I/O interface(s) 36. The I/O interface(s) 36 may be in the form of typical mobile telephone I/O interfaces and may include one or more electrical connectors. As is typical, the I/O interface(s) 36 may be used to couple the mobile telephone 10 to a battery charger to charge a battery of a power supply unit (PSU) 38 within the mobile telephone 10. In addition, or in the alternative, the I/O interface(s) 36 may serve to connect the mobile telephone 10 to a headset assembly (e.g., a personal hands free (PHF) device) that has a wired interface with the mobile telephone 10. Further, the I/O interface(s) 36 may serve to connect the mobile telephone 10 to a personal computer or other device via a data cable for the exchange of data. The mobile telephone 10 may receive operating power via the I/O interface(s) 36 when connected to a vehicle power adapter or an electricity outlet power adapter.

The mobile telephone 10 also may include a system clock 40 for clocking the various components of the mobile telephone 10, such as the control circuit 20. The mobile telephone 10 also may include a position data receiver 44, such as a global positioning system (GPS) receiver, Galileo satellite system receiver or the like.

The mobile telephone 10 also may include a local wireless interface 46, such as an infrared transceiver and/or an RF adaptor (e.g., a Bluetooth adapter), for establishing communication with an accessory, another mobile radio terminal, a computer or another device. For example, the local wireless interface 44 may operatively couple the mobile telephone 10 to a headset assembly (e.g., a PHF device) in an embodiment where the headset assembly has a corresponding wireless interface.

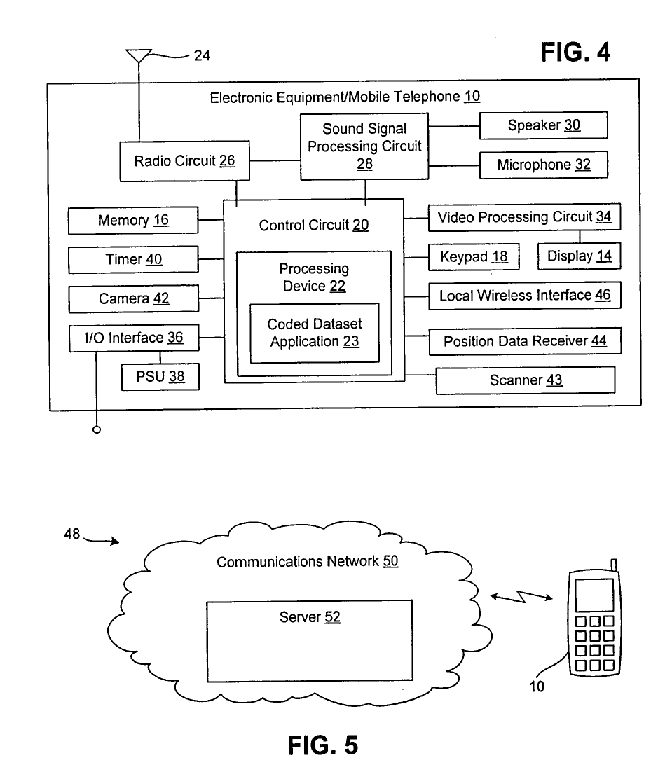

With additional reference to FIG. 5, the mobile telephone 10 may be configured to operate as part of a communications system 48. The system 48 may include a communications network 50 having a server 52 (or servers) for managing calls placed by and destined to the mobile telephone 10, transmitting data to the mobile telephone 10 and carrying out any other support functions. The server 52 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 50 may support the communications activity of multiple mobile telephones 10 and other types of end user devices. As will be appreciated, the server 52 may be configured as a typical computer system used to carry out server functions and may include a processor configured to execute software containing logical instructions that embody the functions of the server 52 and a memory to store such software.

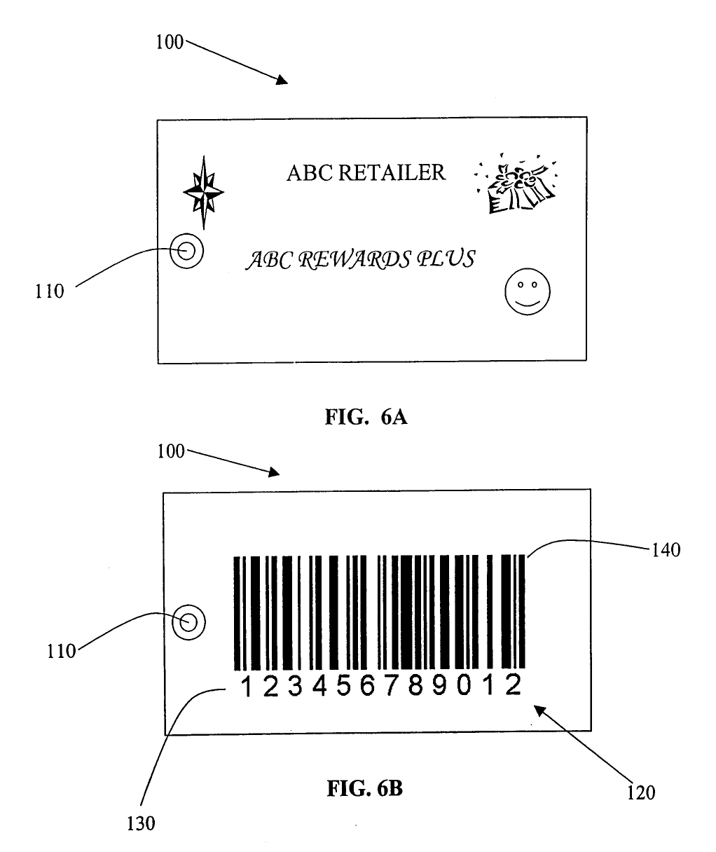

FIGS. 6A-B depict a coded source for a coded dataset. In an exemplary embodiment, the coded dataset source is a coded card, further exemplified as a rewards or discount card 100. It will be appreciated, however, that the coded dataset source need not be a card, but may be any machine readable or scannable device.

FIG. 6A depicts the front view of an exemplary discount card 100, which may include information pertaining to the retailer that issues the card. In this example, the front of the card includes the name of the retailer, “ABC Retailer”, and the name of the rewards program associated with the discount card, “ABC Rewards Plus.” The discount card also may include various designs, colors, or logos, associated with the retailer. The discount card may be a wallet-sized card comparable in dimension to a credit card or bank debit/ATM card. Alternatively, the card may be a smaller keychain-sized card. If a keychain card, the card is provided with a hole 110 for placing the card on a keychain. It will be appreciated that the dimensions and look of the discount card described herein are merely exemplary, and the look and size of the card may be varied.

FIG. 6B depicts a back view of the rewards or discount card 100, which in this embodiment is the coded portion of the card. The position of the code depicted in the figure is exemplary and may be varied. The back of the discount card contains a coded dataset 120 that includes two parts—an input dataset 130 and a coded graphical representation 140. As shown by way of example, the input dataset 130 comprises a numeric string of twelve digits. The coded graphical representation 140 is shown as a linear barcode, as are known in art, comprising a patterned series of vertical rectangular bars of varying thicknesses and spacing. The pattern of the barcode thus includes the number of bars, the varying thicknesses of the bars, and/or the spacing between bars. The pattern of the barcode corresponds with and is unique to the particular input dataset numeric string. In other words, changing the digits in the numeric string will result in a different pattern of bars on the barcode.

It will be appreciated by those skilled in art that the coded dataset 120 may be varied without departing from the scope of the invention. For example, the coded dataset may be a standard known linear barcode format, such as Code 39, Code 128, or UPC, or may be some other barcode format currently known or developed in the future. Depending on the barcode format being used, the input dataset 130 need not be a twelve-digit numeric string. The input dataset may have more or less digits, or may be an alphanumeric combination of numbers, letters, and/or character symbols. In addition, the coded graphical representation 140 need not be a linear barcode, but may be an alternative graphical representation. For example, the coded graphical representation may be a two-dimensional matrix code. In one embodiment, the two-dimensional matrix code is a QR code.

As is known in the art, when a consumer wishes to participate in a discount or rewards program, the consumer provides the retailer with various identifying information, such as name, address phone number, etc. The consumer may also provide information associated with the products of the retailer, such as purchasing preferences or purchasing behavior. The consumer information is entered into the retailer's computer system, and the information also may be assigned a coded dataset unique for that consumer. In the example depicted in the figures, the coded dataset is a linear barcode for the consumer that includes a twelve-digit numeric string and a graphical barcode representation, although, as stated above, other coding schemes may be employed. The consumer then may be issued a card with the barcode (or alternative coded dataset) printed thereon. When the consumer makes a purchase, the coded dataset on the discount card is scanned with a conventional register scanner, such as an optical scanner. The computer system of the retailer can thus track the consumer's purchases. In some rewards programs, a consumer may be awarded a certain number of rewards “points” as a measure of the purchases. When the consumer accumulates a specified number or value of purchases or rewards points, or otherwise meets rewards criteria established by the retailer, the retailer may issue a reward. Rewards vary from retailer to retailer, but may include, for example, free merchandise, discounts on future purchases, access to special promotions, etc.

A consumer may be issued a separate card by each retailer with which the consumer participates in a rewards or discount program. Some consumers may even shop at different retailers of the same category depending on the circumstances. For example, a consumer may not always shop at the same grocery, drug store, gas station, etc. chain, and thus may obtain a discount card for each chain to obtain the benefits of all the various programs. The number of cards easily may become unwieldy and inconvenient to carry. Therefore, the mobile telephone 10 is configured to obtain and store the various coded datasets so that carrying the individual coded cards is not necessary.

Referring to FIG. 4, the mobile telephone 10 has a control circuit 20 containing a processing device 22. Among their functions, to implement the features of the present invention, the control circuit 20 and/or processing device 22 comprise a controller that may execute program code embodied as coded dataset application 23. It will be apparent to a person having ordinary skill in the art of computer programming, and specifically in application programming for cameras, mobile telephones or other electronic devices, how to program a mobile telephone to operate and carry out logical functions associated with application 23. Accordingly, details as to specific programming code have been left out for the sake of brevity. Also, while the code may be executed by control circuit 20 in accordance with an exemplary embodiment, such controller functionality could also be carried out via dedicated hardware, firmware, software, or combinations thereof, without departing from the scope of the invention.

Application 23 includes a code generator program as is well known in the art. In one embodiment, the code generator may be is a linear barcode generator that receives as its input an input dataset comprising a numeric or alphanumeric string. The barcode generator then converts the input dataset to a corresponding coded graphical representation, a linear barcode in this example. As is common, the barcode generator may be capable of generating barcodes of a variety of formats, such as Code 39, Code 128, UPC, and various others. Similarly, should the current formats be updated (or new ones be created), then application 23 may be updated with downloads over the communications network 50 (FIG. 5). Alternatively or additionally, application 23 may have the program capability to convert an input dataset into a two-dimensional matrix code, such as a QR code.

An exemplary method of using a mobile telephone 10 having application 23 is described below. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention.

A user may select application 23 from a conventional menu displayed on display 14 of the mobile telephone 10. Alternatively, the user may select application 23 with a button on keypad 18 dedicated for that purpose.

Once application 23 is selected, the user may be prompted by the display to choose from various options. FIG. 3A depicts an exemplary options menu that gives the user options of creating a new card, displaying cards, or finding a card. To create a new card, the user may select this option from the menu. As shown in FIG. 3B, the user may then be prompted to enter the name of the retailer for the rewards or discount program to be entered. The user then may input an input dataset.

As stated above, a rewards or discount card may contain a coded dataset. The coded dataset includes an input dataset and a coded graphical representation. By way of example, it is assumed that the input dataset is a twelve-digit numeric string, and the coded graphical representation is a linear barcode, substantially of the form depicted in FIG. 6B. As shown in FIG. 3B, the user may input the corresponding numeric string into the mobile telephone using the keypad 18. It will appreciated that the user may input any form of alphanumeric string with keypad 18 in a manner comparable to creating a text message comprising a combination of letters, numbers, and/or symbols.

After the input dataset is inputted, the user may be prompted on the display to select the particular type of coded graphical representation. In one embodiment, a list of common barcode formats is displayed, such as Code 39, Code 128, UPC, or “other.” The list also may include one or more two-dimensional matrix codes, such as the QR code. The user may select the appropriate format from the list, or chooses “other” to cause the display of additional formats. Once a format is selected, application 23 converts the input dataset into a coded graphical representation commensurate with the selected format, and, as shown in FIG. 3C, displays the coded graphical representation on display 14. If the coded graphical representation (e.g. barcode or QR code) on display 14 visually corresponds to the coded graphical representation depicted on the discount card, then the user may accept the coded graphical representation. The rewards or discount program name and corresponding coded graphical representation (e.g., barcode or QR code) are then stored in a memory in mobile telephone 10, such as memory 16. If the display and discount cards do not visually correspond, then the user may select another code format, and the selection process may be repeated until the corresponding format is selected.

It will be appreciated that the code format selection may require a certain level of trial and error. Such trial and error should not be onerous because a few of the code formats are far more common than others. In addition, as the user enters more and more discount programs, the user may become more familiar with the common coding formats, thereby reducing or eliminating the need for trial and error. Additionally, retailers wanting to benefit from the present invention may simply identify on the card the particular code format being utilized.

In an alternative embodiment, application 23 includes a database of popular retail chains and the corresponding code format that a given chain uses on its rewards or discounts cards. In this embodiment, the user does not select the code format manually. Instead, after the input dataset is entered, application 23 generates the coded graphical representation automatically based on the code format associated with the named retailer, as indicated in the database. In this embodiment, therefore, no trial and error is required to select the proper code format for the retailers listed in the database. The database also may be updated to amend or add retailer information, either manually with keypad 18, or by downloading updates over the communications network 50.

Commonly, today's mobile telephones are equipped with a camera assembly 42, and the resolution of camera phones has improved substantially in recent years. As an alternative embodiment, camera 42 may be used to photograph the coded dataset directly from the rewards or discount card. Thus, in this embodiment, the input dataset is the photograph, which application 23 stores in memory. Alternatively, application 23 may be configured to process the photograph using image recognition techniques to read the coded dataset so as to arrive at the input dataset. The input dataset may then be stored with respect to the relevant retailer and used to generate a coded dataset when subsequently selected in the manner described above.

In yet another embodiment, mobile telephone 10 may be equipped with a scanner assembly 43, which may be an optical scanner similar to those used in retail cash registers. The scanner may be used to scan the coded dataset directly from the discount or rewards card. Thus, in this embodiment, the input dataset is the scanned image, which application 23 stores in memory. The use of a camera or scanner also eliminates any trial and error that might otherwise be associated with code format selection.

It will also be appreciated that the coded dataset need not originate from a physical card, but instead may originate from an alternative coded dataset source. For example, the input dataset and code format may be provided by simple text message and entered manually by the user with keypad 18. In addition, a coded dataset may be photographed or scanned from an electronic display or other machine readable media. Other sources of, and means of inputting, a coded dataset may be employed without departing from the scope of the invention.

The typical storage capacity of a mobile telephone is sufficient to accommodate information from all of the rewards or discount cards that a typical consumer may possess. The consumer, therefore, need not carry any of the coded cards. At a retail checkout, a consumer may select from, for example, a conventional menu displayed on display 14, the name of the appropriate retailer as previously entered. FIG. 3D depicts an exemplary menu from which a retailer may be selected. Once selected, application 23 causes to be displayed on display 14 the coded graphical representation (e.g. barcode or QR code) for that rewards or discount program (see FIG. 3C), which is the same as the coded graphical representation depicted on the corresponding discount card. Display 14 may then be subjected to a reading device for interpreting the coded graphical representation. In an exemplary embodiment, the reading device may be a conventional optical scanner as one might find on a cash register, and the cashier scans the display 14 in the same manner as one would scan the code on a discount card. In this manner, a consumer may attain the benefits of various rewards and discount programs without suffering the inconvenience of carry numerous cards.

The information pertaining to all the discount cards and rewards programs may be portable. In this manner, should a user acquire a new mobile telephone or other new electronic device, the information may be transferred to the new device without reentering the information. For example, the information pertaining to all the discount cards and rewards programs may be downloaded or saved to a memory card, SIM card, or other conventional external memory device, and then uploaded to a new device. Alternatively, the information may be transferred to a new device via a conventional Bluetooth or other network connection.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. An electronic device comprising:
an input device for inputting a plurality of input datasets, wherein each input dataset corresponds to a coded graphical representation;
a controller that converts an input dataset selected from the plurality of input datasets, in response to a user input, into the corresponding coded graphical representation; and
a display that displays the corresponding coded graphical representation, wherein the displayed coded graphical representation may be subjected to a reading device for interpreting the coded graphical representation.

2. The electronic device according to claim 1, wherein one or more of the input datasets originate from coded cards.

3. The electronic device of claim 1, wherein the input device is a keypad, and the controller is configured to receive as input datasets numeric or alphanumeric strings that are inputted using the keypad.

4. The electronic device of claim 1, wherein the input device is a camera, and the controller is configured to receive as input datasets photographs that are inputted by photographing the coded graphical representations.

5. The electronic device of claim 1, wherein the input device is a scanner, and the controller is configured to receive as input datasets scanned images that are inputted by scanning the coded graphical representations.

6. The electronic device of claim 1, wherein the electronic device is a mobile telephone.

7. The electronic device of claim 1, wherein the controller converts the selected input data set to a linear barcode.

8. The electronic device of claim 7, wherein the linear barcode if one of a Code 39, Code 128, or UPC linear barcode.

9. The electronic device of claim 1, wherein the controller converts the selected input dataset to a two-dimensional matrix code.

10. The electronic device of claim 9, wherein the two-dimensional matrix code is a QR code.

11. A method of using coded graphical representations in conjunction with an electronic device comprising the steps of:
inputting into the electronic device a plurality of input datasets, wherein each input dataset corresponds to a coded graphical representation;
selecting one input dataset from the plurality of input datasets;
converting the selected input dataset within the electronic device to the corresponding coded graphical representation;
displaying the corresponding coded graphical representation on a display on the electronic device; and
subjecting the displayed coded graphical representation on the display to a reading device for interpreting the coded graphical representation.

12. The method according to claim 11, wherein one or more of the input datasets originate from coded cards.

13. The method according to claim 11, wherein the coded graphical representation is a linear barcode.

14. The method according to claim 13, wherein the linear barcode is one of a Code 39, Code 128, or UPC barcode.

15. The method according to claim 11, wherein the coded graphical representation is a two-dimensional matrix code.

16. The method according to claim 15, wherein the two-dimensional matrix code is a QR code.

17. The method according to claim 11, wherein the electronic device has a keypad, and the input datasets are numeric or alphanumeric strings that are inputted using the keypad.

18. The method according to claim 11, wherein the electronic device has a camera, and the input datasets are photographs that are inputted by photographing the coded graphical representations.

19. The method according to claim 1, wherein the electronic device has a scanner, and the input datasets are scanned images that are inputted by scanning coded graphical representations.

20. The method according to claim 1, wherein the reading device is an optical scanner.

21. The method according to claim 1, wherein the electronic device is a mobile telephone.
